(19) United States
(12) Patent Application Publication
(10) Pub. No.: US 2023/0042411 A1
(43) Pub. Date: Feb. 9, 2023

(54) VARIABLE-LENGTH CONNECTING ROD FOR AN ENGINE WITH A CONTROLLED COMPRESSION RATIO

(71) Applicant: MCE 5 Development, Villeurbanne (FR)

(72) Inventor: René-Pierre BERTHEAU, Montagny (FR)

(21) Appl. No.: 17/755,606

(22) PCT Filed: Nov. 4, 2020
(86) PCT No.: PCT/FR2020/051987

§ 371 Date: Aug. 26, 2022

(30) Foreign Application Priority Data
Nov. 4, 2019 (FR) FR1912336

(51) Int. Cl. F02B 75/04; F16C 7/06; F02D 15/02; F16C 23/10; F16C 9/04

(52) U.S. Cl. CPC F02B 75/045; F16C 7/06; F02D 15/02; F16C 23/10; F16C 9/04; F16C 2360/22

(57) ABSTRACT

A variable-length connecting rod comprises: a connecting rod head, designed to establish a pivot connection with a crankpin of a crankshaft, a hydraulic circuit for controlling the length of the connecting rod, and a system for controlling the hydraulic circuit. The control system comprises: at least one linear hydraulic slide arranged within a housing of the connecting rod head, at least a first shoe arranged on a sidewall of the connecting rod head, suitable for undergoing a bearing force exerted by a controlling member, the bearing force allowing the slide to be moved, a return means for bringing the slide back to its resting position in the absence of the bearing force, At and at least a second shoe arranged on the sidewall of the connecting rod head and suitable for undergoing the bearing force.

### CROSS-REFERENCE TO RELATED APPLICATIONS

This application is a national phase entry under 35 U.S.C. § 371 of International Patent Application PCT/FR2020/051987, filed Nov. 4, 2020, designating the United States of America and published as International Patent Publication WO 2021/089940 A1 on May 14, 2021, which claims the benefit under Article 8 of the Patent Cooperation Treaty to French Patent Application Serial No. FR1912336, filed Nov. 4, 2019.

### TECHNICAL FIELD

The present disclosure relates to an engine with a variable compression ratio, implementing a connecting rod with a controlled variable length.

### BACKGROUND

Among the solutions allowing the compression ratio of an engine to be made variable, solutions implementing a connecting rod whose center distance (that is to say, the length of the connecting rod) can be controlled are known. For example, when the connecting rod has a first length, the engine is configured to present a first compression ratio, and when the connecting rod has a second length, the engine is configured to present a second compression ratio.

The connecting rod can be of the telescoping type, as is known, for example, from U.S. Patent Application US2016237889, or of the eccentric type. In general, the connecting rod is fitted with a device, often of a hydromechanical nature, allowing its length to be adjusted.

Whatever shape is chosen, the connecting rod can be configured to allow continuous adjustment of its length, between its first length and its second length, so as to continuously adjust the compression ratio of the engine (so-called “continuous rate” connecting rod). Alternatively, the connecting rod can be called “bistable” or “bi-rate”: then only its first and its second length form stable positions allowing two operating modes of the engine to be defined, each mode corresponding to a determined compression ratio. The connecting rod can also be “tri-rate,” three defined lengths in this case forming stable positions associated with defined compression ratios of the engine.

Controlling the connecting rod involves controlling the hydromechanical device for adjusting its length to a target length, so as to give the engine a setpoint compression ratio.

According to a first approach known, for example, from document U.S. Patent Application US2017089257, the transmission of the setpoint is carried out mechanically. For example, the control is obtained by clashing, while the connecting rod is driven by the crankshaft, between an actuator of the adjustment device (for example, the slide of a hydraulic distributor) and a control part attached to the crankcase. The clashing occurs at very high velocity, and this impact control requires extremely precise positioning of the control part in the engine block, which makes its manufacture particularly complex and expensive. Furthermore, this control mode leads to significant acoustic emission and rapid wear of the parts that come into contact.

According to another known approach, the transmission of the setpoint is carried out by hydraulic means. Thus, the aforementioned U.S. Patent Application US2016237889 provides for the use of the connecting rod bearing a lubrication circuit to act on an actuator of the connecting rod length adjustment device. This type of hydraulic control has the disadvantage of a high inertia on the command and a high sensitivity to the engine speed.

### BRIEF SUMMARY

The present disclosure aims to overcome all or some of the aforementioned drawbacks. It relates, in particular, to a variable-length connecting rod controlled by mechanical transmission, capable of cooperating with an external controlling member, without impact.

The present disclosure relates to a variable-length connecting rod, the body of which extends along a longitudinal axis and comprising:
A connecting rod head, designed to establish a pivot connection, along a transverse axis perpendicular to the longitudinal axis, with a crankpin of a crankshaft,
A hydraulic circuit for controlling the length of the connecting rod, and
A system for controlling the hydraulic circuit.

The control system comprises:
At least one linear hydraulic slide, arranged within a housing of the connecting rod head, and capable of occupying a first resting position and at least one second position, each position allowing fluidic communication with the hydraulic circuit to be opened or closed,
At least a first shoe arranged on a sidewall of the connecting rod head and secured to one end of the slide, suitable for undergoing a bearing force exerted by an annular controlling member, coaxial with the crankpin and external to the connecting rod, the bearing force allowing the slide to be moved into the second position,
A return means for bringing the slide back to its first resting position in the absence of the bearing force, and
At least a second shoe arranged on the sidewall of the connecting rod head and suitable for undergoing the bearing force.

According to other advantageous and non-limiting features of the present disclosure, taken individually or in any technically feasible combination:
the first and second shoes are arranged so that the center of gravity of the forces that the shoes undergo when the bearing force is applied to them is located substantially at the center of the connecting rod head;
at least one of the shoes comprises end stops to limit its possible movement along the transverse axis;
the hydraulic circuit comprises at least two hydraulic chambers, each connected to the slide by at least one duct, the chambers being associated with at least one hydraulic piston, the movement of which is suitable for modifying the length of the connecting rod along the longitudinal axis; in particular, the chambers being associated with a central piston in the case of a telescopic connecting rod, and the chambers being associated respectively with a first piston and a second piston in the case of an eccentric connecting rod;
the (at least one) slide makes it possible, depending on the position it occupies, to establish oil circulation between a hydraulic chamber and an oil supply, or to establish oil circulation between a hydraulic chamber and an oil drain, or to establish oil circulation between the two hydraulic chambers, or to block any circulation of oil with the two hydraulic chambers;
the oil supply is configured to recover lubricating oil from the connecting rod head bearings;
the (at least one) slide comprises at least one valve allowing the direction of oil circulation to be defined;
the hydraulic circuit comprises a duct connecting the two hydraulic chambers and provided with a valve allowing the direction of oil circulation to be defined;
the connecting rod comprises a return or push-back element connected to at least one hydraulic piston; and
at least one duct, connecting a hydraulic chamber and the slide, comprises a shutter device configured to allow the circulation of oil between the hydraulic chamber and the slide when the hydraulic piston reaches a determined position.

### BRIEF DESCRIPTION OF THE DRAWINGS

Other features and advantages of the present disclosure will become apparent from the following detailed description of example embodiments of the present disclosure, with reference to the accompanying drawings, in which:

FIG. 1A shows a telescopic connecting rod according to the present disclosure;

FIGS. 1B and 1C show an eccentric connecting rod according to the present disclosure;

FIGS. 2A (exploded view), 2B and 2C show all or part of a control system for a connecting rod according to the present disclosure;

FIGS. 3A and 3B show the hydraulic diagram for “bi-rate” operation, without transfer between the chambers of the hydraulic connecting rod length control circuit, respectively of an eccentric connecting rod and a telescopic connecting rod according to the present disclosure;

FIGS. 3C and 3D show the hydraulic diagram for a “bi-rate” operation, with transfer between the chambers of the hydraulic circuit for controlling the length of the connecting rod, respectively of a telescopic connecting rod and an eccentric connecting rod according to the present disclosure;

FIGS. 4A and 4B show the control system for an eccentric connecting rod according to the present disclosure, and the associated hydraulic diagram for “bi-rate” operation, without transfer between the hydraulic chambers;

FIGS. 5A and 5B show the control system for a telescopic connecting rod according to the present disclosure, and the associated hydraulic diagram for “tri-rate” operation, with transfer between the hydraulic chambers;

FIGS. 5C and 5D show a variant of the control system for a telescopic connecting rod according to the present disclosure, and the associated hydraulic diagram for “tri-rate” operation, with transfer between the hydraulic chambers;

FIGS. 6A-6C show the control system for an eccentric connecting rod according to the present disclosure, and the associated hydraulic diagram for “continuous rate” operation, without transfer between the hydraulic chambers;

FIGS. 7A-7D show the control system for a telescopic connecting rod according to the present disclosure, and the associated hydraulic diagram for “continuous rate” operation, with transfer between the hydraulic chambers;

FIGS. 8A-8C show controlling members borne by the crankshaft and configured to cooperate with a connecting rod according to the present disclosure; and

FIG. 8D shows the control system for a connecting rod according to the present disclosure cooperating with a controlling member borne by the crankshaft.

### DETAILED DESCRIPTION

The present disclosure relates to a variable-length connecting rod 10 for a controlled compression ratio engine.

It should be noted that the same references in the figures may be used for the same type of elements or elements that perform the same function.

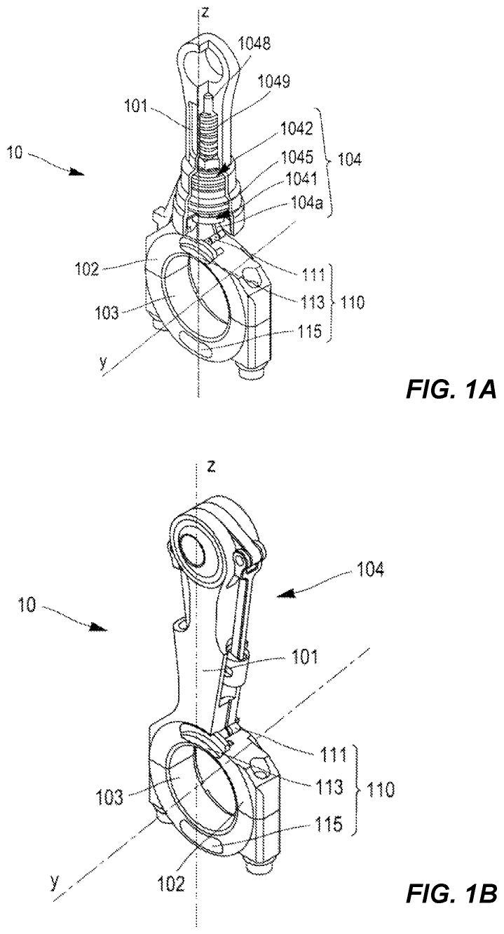

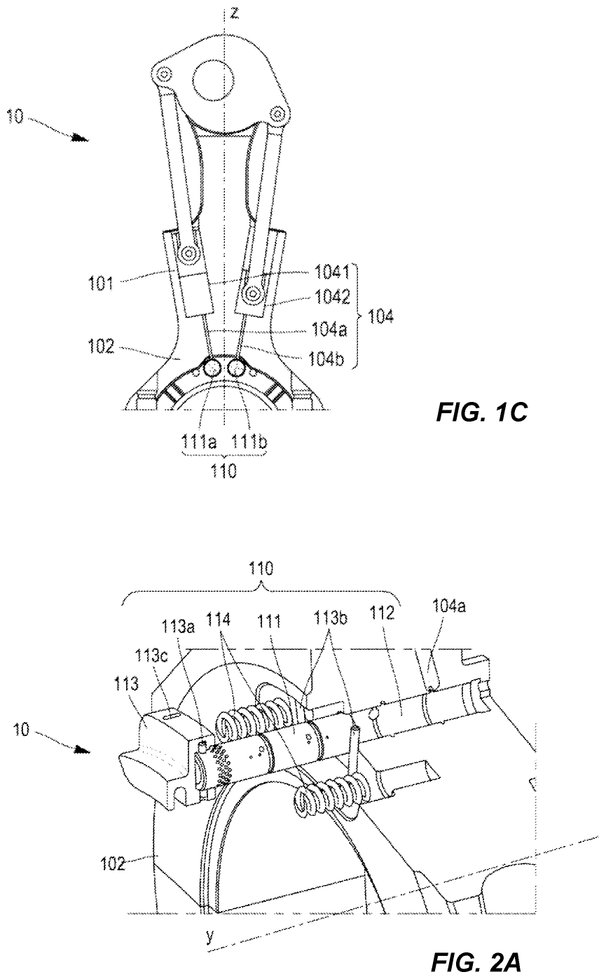

The connecting rod 10 comprises a body 101 extending along a longitudinal axis z. The connecting rod 10 according to the present disclosure can be of the telescopic (FIG. 1A) or eccentric (FIGS. 1B, 1C) type: a central cylinder mechanism or an eccentric mechanism is then arranged in the body 101 of the connecting rod 10. These mechanisms are part of a hydraulic circuit 104, comprised in the connecting rod 10. In the two connecting rod configurations, the hydraulic circuit 104 preferably comprises at least two hydraulic chambers 1041, 1042 associated with at least one hydraulic piston. In particular, the hydraulic chambers 1041, 1042 are associated with a central piston 1045 in the case of a telescopic connecting rod (FIG. 1A), and the chambers 1041, 1042 are respectively associated with a first piston and a second piston in the case of an eccentric connecting rod (FIG. 1C). The modification of the supply, the discharge or the circulation of oil in or between these two hydraulic chambers 1041, 1042 will induce the movement of the hydraulic piston(s), which movement allows the connecting rod length to be modified along the longitudinal axis z.

Advantageously, in the case of the telescopic connecting rod (FIG. 1A), preference will be given to long guiding, between the part attached to the connecting rod base (body 101) and the part attached to the connecting rod head 102, which can be done on the one hand at the piston 1045 and on the other hand at the sliding pivot connection 1048, in order to ensure the take-up of external forces when the connecting rod 10 is inclined and to limit friction or even jamming thereof. As illustrated in FIG. 1A, the central piston 1045 is held by a nut with a stud extending under the bore of the connecting rod base, thus creating the sliding pivot connection 1048. Furthermore, preference will be given to a double spring with opposing pitch 1049 in order to avoid creating an opposing torque in the mechanism.

The connecting rod 10 also comprises a connecting rod head 102, designed to establish a pivot connection, along a transverse axis y perpendicular to the longitudinal axis z, with a crankpin 2 of a crankshaft 200 of the controlled compression ratio engine. As on a conventional engine, bearings 103 are provided to limit friction between the connecting rod head 102 and the crankpin 2.

The connecting rod 10 further comprises a control system 110, intended to control the hydraulic circuit 104; the control system 110 will make it possible to manage the fluidic communication with the hydraulic circuit 104, that is to say, to open or close the communication to adjust the circulation of oil between the hydraulic circuit 104 and the outside and/or the circulation of oil in the hydraulic circuit 104. It should be noted that the oil intended to circulate in this hydraulic circuit 104 is that of the engine.

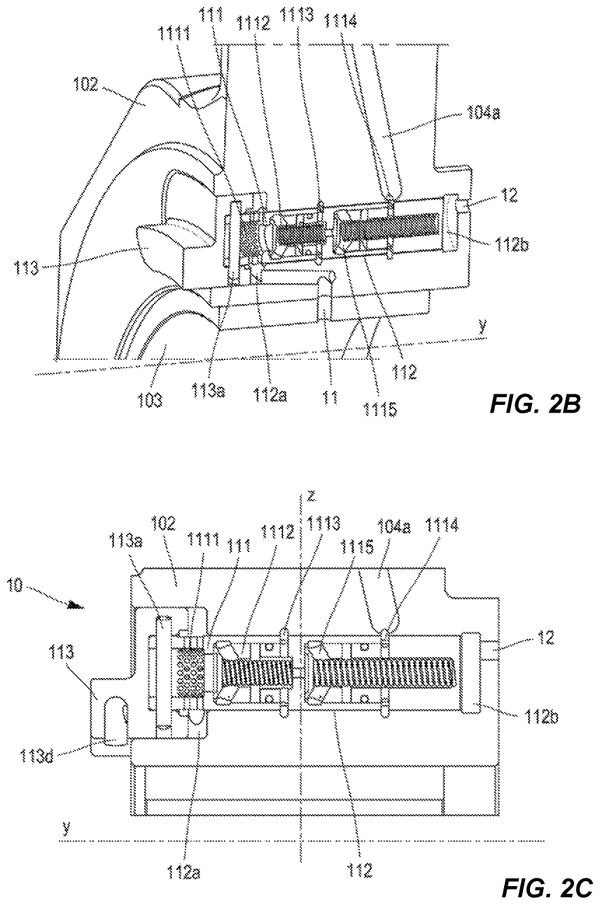

The control system 110 comprises at least one linear hydraulic slide 111, arranged in a housing 112 of the head 102 of the connecting rod 10 (FIG. 2A). The control system 110 is in fluidic connection with the hydraulic circuit 104 via at least one duct 104a arranged in the connecting rod head 102 and communicating with the housing 112.

The housing 112 is preferably parallel to the transverse axis y. The slide 111 is cylindrical in shape and has an outer diameter typically between 4 and 6 mm.

Advantageously, the housing 112 has a central section in which the slide 111 is housed, a front section 112a in communication with the oil supply 11 and a rear section 112b, opposite the front section 112a (FIGS. 2B, 2C). In some embodiments described later, the rear section 112b communicates with the oil drain 12.

The small space requirement of the slide 111 has the advantage of limiting the deformation of its housing 112 when forces are transmitted to the connecting rod 10; it also has the advantage of easier placement of the slide 111 in the head 102.

No sealing is provided between the slide 111 and the housing 112: the leak generated allows a gradual renewal of the oil in the hydraulic circuit 104. The small diameter of the slide 111 allows better control of this leak.

In the embodiments for which the rear section 112b of the housing 112 communicates with the oil drain 12, the oil resulting from this leak is evacuated at the drain 12, thus avoiding hydraulic compression in the rear section 112b.

Advantageously, the slide 111 comprises a filter 1111 through which the oil arriving from the supply 11 will pass, and at least a first valve 1112 allowing the circulation of oil from the filter 1111 toward the interior of the slide 111. It also comprises at least one orifice 1113 to establish fluidic communication between the inside of the slide 111 and at least one duct of the hydraulic circuit 104 (FIGS. 2B, 2C).

The slide 111 is said to be linear because it is able to move along the transverse axis y, in the housing 112. Thus, it is capable of occupying a first resting position P1 and at least one second position P2. A position of the slide 111 will allow:

either establishment of fluidic communication, through the slide 111, between the hydraulic circuit 104 and the oil supply 11,

or establishment of fluidic communication, through the slide 111, between the hydraulic circuit 104 and the oil drain 12,

or establishment of fluidic communication, through the slide 111, between two hydraulic chambers of the circuit 104, and

or blocking of the fluidic communication with the hydraulic circuit 104, isolating the latter in a closed circuit.

These different configurations will be detailed later in the specific embodiments.

The control system 110 also comprises a first shoe 113 placed on a sidewall of the connecting rod head 102 and secured to one end of the slide 111. The first shoe 113 is suitable for undergoing at least one bearing force exerted by a controlling member 50 external to the connecting rod, the member 50, for example, being borne by the crankshaft 200. This bearing force, transmitted to the slide 111 by the first shoe 113, will cause the linear displacement of the slide 111, to cause it to occupy its (at least one) second position P2.

In the context of the present disclosure, the external controlling member 50 has an annular surface, coaxial with the crankpin 2, positioned opposite the sidewall of the connecting rod head 102.

The external controlling member 50 is configured to move along the transverse axis y and can thus come into contact with the first shoe 113 and exert a bearing force thereon. Examples of embodiments of the controlling member 50 external to the connecting rod 10 and cooperating therewith will be described below.

By way of example, as illustrated in FIGS. 2A-2C, the first shoe 113 is kept secured to the end of the slide 111 by way of cylindrical pins 113a. The first shoe 113 also comprises end stops 113b to limit its possible movement along the transverse axis y. These stops can be made by way of two cylindrical pins 113b, secured to the head 102, plugged into windows 113c arranged in the first shoe 113, thus limiting the movement of the first shoe 113 in translation along the transverse axis y to the size of the window. Using such stops 113b also allows the preliminary assembly of the slides 111 of the connecting rod 10 before assembly on the crankshaft 200.

Advantageously, the front section 112a of the housing 112 is configured to partially house the first shoe 113. In the example of FIGS. 2B, 2C, the front section 112a has an enlarged housing allowing the first shoe 113 to establish a sliding connection along the transverse axis y, with the connecting rod head 102.

The control system 110 also comprises a return means 114 (FIG. 2A), for example, springs, to bring the slide 111 back into the first resting position P1, in the absence of the bearing force exerted on the first shoe 113.

The control system 110 also comprises a second shoe 115 arranged on the same sidewall of the connecting rod head 102 as the first shoe 113 (FIGS. 1A and 1B). The second shoe 115 is also suitable for undergoing the bearing force exerted by the external controlling member 50. It is advantageously configured to balance the bearing force exerted by the external controlling member 50 and to avoid the appearance of parasitic torque between the first shoe 113 and the controlling member 50. For this reason, the first 113 and second 115 shoes are arranged so that the center of gravity of the forces that the shoes undergo when the bearing force is applied to them is located substantially at the center of the connecting rod head 102. According to one possible embodiment, the second shoe 115 is symmetrical to the first shoe 113 with respect to the center of the connecting rod head 102 and has a contact surface equivalent to the first shoe 113. As illustrated in FIGS. 1A and 1B, the first 113 and second 115 shoes may be aligned along the longitudinal axis z, the first as close as possible to the body 101 of the connecting rod 10 and the second at the cap of the connecting rod head 102. Alternatively, several second shoes 115 could be placed on the sidewall of the connecting rod head 102, and arranged so as to balance the forces.

Like the first shoe 113, the second shoe 115 establishes a sliding connection along the transverse axis y with the connecting rod head 102: its movement amplitude is equivalent to that of the first shoe 113. Return means 114 and end stops can be used, as stated above for the first shoe 113.

It should be noted that the oil supply 11 can be done from a bore through a bearing 103 opening into the front section 112a of the housing 112, as illustrated in FIG. 2B. Alternatively, the first shoe 113 may be provided with a cavity 113d configured to collect the lubricating oil from the bearings 103 at the sidewall of the connecting rod head 102, the cavity 113d moreover communicating with the front section 112a of the housing 112 (FIG. 2C).

Control System for Telescopic or Eccentric Connecting Rod

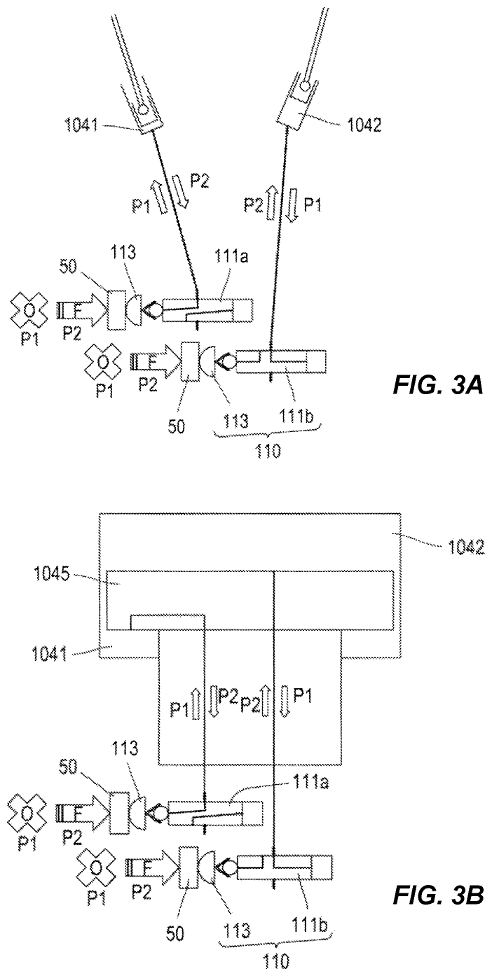

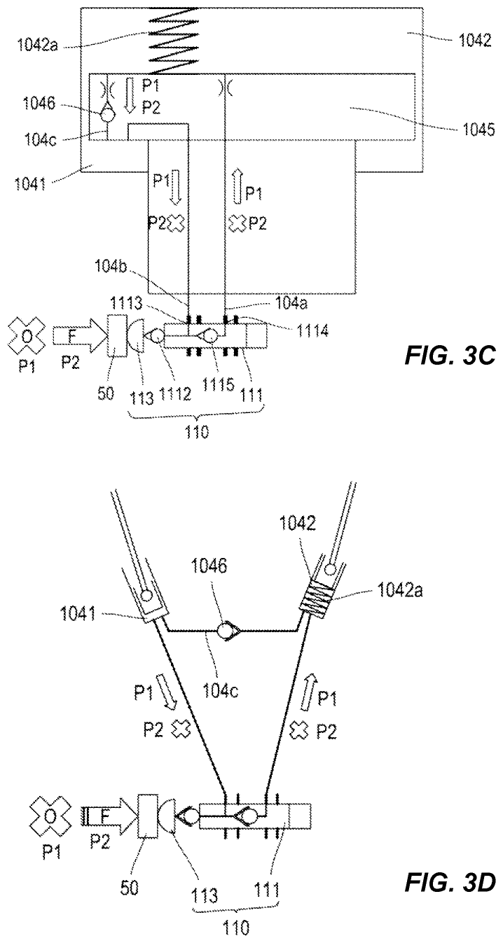

A so-called eccentric variable-length connecting rod and a so-called telescopic variable-length connecting rod share the similarity between their hydraulic circuits 104. Indeed, in each case, the objective is to be able to control the oil volume of at least two hydraulic chambers 1041, 1042 (FIGS. 3A, 3B). The difference in operation lies in the mechanics of extending the connecting rod and not in the control. Thus, the same control system 110 can be used either for an eccentric connecting rod or for a telescopic connecting rod.

FIG. 3A illustrates a control system comprising two slides 111a, 111b, suitable for an eccentric connecting rod, and FIG. 3B illustrates the same control system for a telescopic connecting rod. The control system 110 remains identical in both cases and is thus made up of a first shoe 113 (and a second shoe 115—not shown), on which an external controlling member 50 exerts a pressing force, allowing the actuation of a first slide 111a and a second slide 111b, which control the oil supply and discharge, respectively, of the first hydraulic chamber 1041 and of the second hydraulic chamber 1042. It should be noted that in the examples of FIGS. 3A and 3B, the control system 110 does not allow the transfer of oil between the two chambers 1041, 1042 of the hydraulic circuit 104.

The operating mode of the control system 110 illustrated in FIGS. 3A and 3B is detailed below, with reference to a “bi-rate” eccentric variable-length connecting rod.

Another important aspect of the variable-length connecting rod according to the present disclosure concerns the desire, or not, to transfer part of the oil from one chamber 1041, 1042 of the hydraulic circuit 104 into the other, when changing the length of the connecting rod. If the transfer of oil between the hydraulic chambers 1041, 1042 is desired, it is necessary to adapt the hydraulic circuit 104 accordingly by adding a fluidic connection between the two chambers 1041, 1042. It should be noted that this fluidic connection may be independent of or dependent on the position of the slide(s) 111a, 111b. As for the example illustrated in FIGS. 3C and 3D, the fluidic connection could be ensured by a transfer duct 104c. The transfer duct 104c advantageously comprises a device for directing the flow of oil such as, for example, a non-return valve 1046.

This transfer capacity between the chambers 1041, 1042 of the hydraulic circuit 104 is more commonly envisaged in the case of telescopic connecting rods, but could be applied to eccentric connecting rods. FIGS. 3C and 3D illustrate a control system 110 for a telescopic connecting rod and an eccentric connecting rod, respectively, with transfer between the two hydraulic chambers 1041, 1042. The control system 110 comprises a single slide 111 actuated by the first shoe 113, on which the exterior controlling member 50 exerts the bearing force. The control system 110 remains identical in both connecting rod cases.

The length of the connecting rod 10 is maximal in the absence of bearing force applied to the first shoe 113, the slide 111 then being in its resting position P1 and allowing the circulation of the oil from the first hydraulic chamber 1041 to the second hydraulic chamber 1042; the transfer of oil from the second chamber 1042 to the first chamber 1041 is also possible via the transfer duct 104c. A return or push-back element 1042a (illustrated by a spring 1042a arranged in the hydraulic chamber 1042 in FIGS. 3C, 3D) makes it possible to guarantee the elongation of the connecting rod 10 owing to a force, independent of the external forces applied to the connecting rod, during an engine cycle. Thus, the second chamber 1042, via the action of the spring 1042a, will extend by pushing back the piston 1045. It should be noted that the return or push-back element 1042a may be located outside the chamber 1042 (in particular, in the case of the connecting rod with an eccentric) and perform the same function as described above.

The connecting rod length is minimal when the external controlling member 50 applies a bearing force on the first shoe 113, which moves the slide 111 into a second position P2 that will block the circulation of oil and isolate the hydraulic circuit 104 in a closed circuit. The oil can then only transfer from the hydraulic chamber 1042 to the hydraulic chamber 1041 due to the valve 1046 on the transfer duct 104c. The transfer occurs gradually when the connecting rod is subjected to external compression forces (in particular, during the compression and combustion phases of the engine cycle), causing the connecting rod length to change by ratchet effect, until the minimum length is reached.

Bi-Rate Connecting Rod

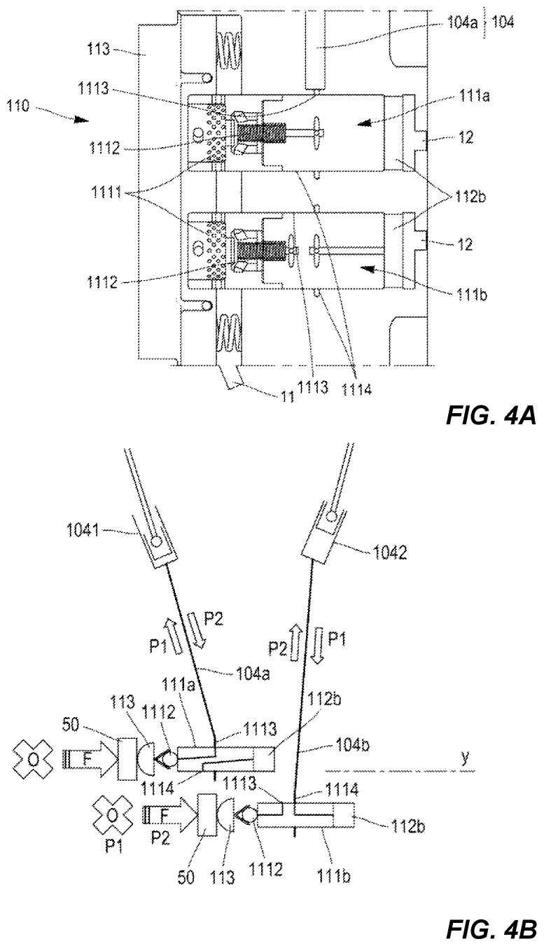

According to a first embodiment, the variable-length connecting rod 10 uses bi-rate operation, without transfer between the chambers 1041, 1042 of the hydraulic circuit 104 (FIGS. 3A, 3B, 4A, 4B). It should be recalled that a connecting rod 10 is said to be “bi-rate” when it can operate with two defined lengths: a maximum length corresponding to a maximum compression rate of the engine, and a minimum length corresponding to a minimum compression rate.

The first embodiment is described below with an eccentric connecting rod (FIGS. 3A, 4A, 4B). It should be noted, however, that the control system 110 according to this first embodiment could equally well be applied to a telescopic connecting rod (FIG. 3B).

The hydraulic control circuit 104 of the connecting rod 10 therefore comprises an eccentric mechanism. This mechanism is provided with two connecting rods respectively attached to a first and to a second hydraulic piston sliding respectively in a first 1041 and a second 1042 chamber (FIG. 1C).

In this first embodiment, the control system 110 comprises two slides 111a, 111b (FIGS. 4A, 4B). And the hydraulic circuit 104 comprises a duct 104a to connect one of the two slides 111a to the first chamber 1041 and a duct 104b to connect the other slide 111b to the second chamber 1042.

Each slide comprises a filter 1111, at its end secured to the first shoe 113, through which the oil passes from the oil supply 11. Each slide 111a, 111b also comprises a first inlet valve 1112, which allows the circulation of oil from the filter 1111 to the interior of the slide and not the reverse circulation. Each slide 111a, 111b finally comprises two orifices 1113, 1114 allowing the establishment of fluidic communication with the hydraulic circuit 104 when one and/or the other orifice 1113, 1114 is opposite a duct 104a, 104b of the circuit 104.

The fluidic communication can include supplying the hydraulic circuit 104, in which case the circulation of oil is established from the supply 11 toward the duct 104a, 104b, passing through the slide 111a, 111b; alternatively, the fluidic communication may include discharging the oil from the hydraulic control circuit 104, the oil circulation then being established from the duct 104a, 104b toward the drain 12, passing through the slide 111a, 111b.

FIG. 4B illustrates the operation of the connecting rod 10 according to this first embodiment.

The first resting position P1 of the slides 111a, 111b is obtained when no bearing force is exerted on the first shoe 113 by the external controlling member 50.

In this first resting position P1, one of the slides 111a is configured to supply oil to the first chamber 1041 to which it is connected by the duct 104a. In practice, the oil coming from the supply 11 and having passed through the filter 1111 of the slide passes through the first valve 1112 to reach the orifice 1113 of the slide 111a, placed opposite the duct 104a, when the slide 111a is in the first resting position P1. The external combustion and inertia forces undergone by the combustion piston of the engine and acting on the eccentric mechanism of the connecting rod will promote the circulation of the oil toward the first chamber 1041, the return of the oil from the first chamber 1041 in the opposite direction being prohibited by the first valve 1112.

Still in the first resting position P1, the other slide 111b is configured to discharge the oil from the second chamber 1042 to which it is connected by the duct 104b. In practice, the orifice 1114 of the slide 111b, which communicates with the rear section 112b of the housing 112 and therefore with the drain 12, is placed opposite the duct 104b. Combustion and inertia forces will here again favor the circulation of the oil from the second chamber 1042 toward the drain 12.

In the first resting position P1 of the slides 111a, 111b, the first chamber 1041 is supplied with oil and the second chamber 1042 is emptied, which makes it possible to adjust the connecting rod to a maximum length, corresponding to a maximum rate of the engine.

The second position P2 of the slides 111a, 111b is obtained following a translation of the slides 111a, 111b along the transverse axis y, when a force F is applied to the first shoe 113, by the external controlling member 50.

In this second position P2, one of the slides 111a is configured to discharge the oil from the first chamber 1041 via the duct 104a. In practice, the orifice 1114 of the slide 111a, which communicates with the rear section 112b of the housing 112 and therefore with the drain 12, is placed opposite the duct 104a. Combustion and inertia forces will again promote the circulation of the oil.

Still in this second position P2, the other slide 111b is configured to supply oil to the second chamber 1042 via the duct 104b. In practice, the oil coming from the supply 11 and having passed through the filter 1111 of the slide passes through the first valve 1112 to reach the orifice 1113 of the slide 111b, placed opposite the duct 104b. The circulation of oil toward the second chamber 1042 is favored by the combustion and inertia forces undergone by the connecting rod 10.

In the second position P2 of the slides 111a, 111b, the second chamber 1042 is supplied with oil and the first chamber 1041 is emptied, which makes it possible to adjust the connecting rod 10 to a minimum length, corresponding to a minimum rate of the engine.

The change in center distance of the connecting rod 10 according to the present disclosure takes place owing to the combustion and inertia forces undergone by the connecting rod 10, which cause the circulation of the oil in the hydraulic circuit 104 and through the slides 111, 111a, 111b of the control system 110, gradually inducing the change in length of the connecting rod. This is true for the first embodiment that has just been described and also for the other embodiments to follow in the description.

According to a second embodiment, the variable-length connecting rod 10 uses bi-rate operation, with transfer between the chambers 1041, 1042 of the hydraulic circuit 104 (FIG. 3C, 3D). The second embodiment is described below with a telescopic connecting rod (FIG. 3C). It should be noted, however, that the control system 110 according to this second embodiment could equally well be applied to an eccentric connecting rod (FIG. 3D).

The hydraulic circuit 104 for controlling the connecting rod 10 comprises a telescopic mechanism. The telescopic mechanism is arranged in the body 101 of the connecting rod 10 and provided with a central jack defining an upper chamber 1042 (or second chamber) and a lower chamber 1041 (or first chamber) on either side of a hydraulic piston 1045, called central piston 1045, the lower chamber 1041 being on the side of the connecting rod head 102 (FIG. 3C). Advantageously, the upper chamber 1042 and the lower chamber 1041 have equivalent sections.

In this second embodiment, the control system 110 comprises a single slide 111. The hydraulic circuit 104 comprises a duct 104a to connect the slide 111 to the upper chamber 1042 and a duct 104b to connect the slide 111 to the lower chamber 1041. The central piston 1045 comprises a transfer duct 104c connecting the two chambers 1041, 1042; a valve 1046 (hereinafter called the third valve) disposed on the duct 104c allows the circulation of oil only from the upper chamber 1042 to the lower chamber 1041.

As described above, the slide 111 comprises a filter 1111, at its end secured to the first shoe 113, through which the oil passes from the oil supply 11. It also comprises a first inlet valve 1112, which allows the circulation of oil from the filter 1111 to the interior of the slide and not the reverse circulation. It further comprises a second valve 1115, in series with the first valve 1112 (FIG. 2B, 2C). The slide 111 comprises at least two orifices 1113, 1114, each downstream of a valve 1112, 1115, allowing establishment of fluidic communication with the hydraulic circuit 104 when one and/or the other of the orifices 1113, 1114 is opposite a duct 104a, 104b of the circuit 104. The fluidic communication may include supplying the hydraulic circuit 104 and circulating the oil from the lower chamber 1041 to the upper chamber 1042, via the ducts 104a, 104b, passing through the slide 111. Alternatively, the fluidic communication can be blocked, putting the hydraulic circuit 104 in a closed circuit, a transfer via the transfer duct 104c only being possible from the upper chamber 1042 to the lower chamber 1041.

In the second embodiment, provision is made for the slide 111 to be able to occupy two different positions along the transverse axis y. The first resting position P1 of the slide 111 is established in the absence of bearing force exerted on the first shoe 113 by the external controlling member 50. The slide 111 is then configured to supply oil to the upper chamber 1042 and to allow oil to circulate between the lower chamber 1041 and the upper chamber 1042. In practice, the orifice 1113 between the first 1112 and the second 1115 valves is in fluidic communication with the lower chamber 1041, and the orifice 1114 downstream of the second valve 1115 is in fluidic communication with the upper chamber 1042. Due to the presence of the third valve 1046, preventing the circulation of fluid from the lower chamber 1041 to the upper chamber 1042, the oil coming from the supply 11 and having passed the first inlet valve 1112 circulates through the second valve 1115 and supplies the upper chamber 1042. Similarly, the oil from the lower chamber 1041, blocked by the first inlet valve 1112, circulates through the second valve 1115 and supplies the upper chamber 1042. The upper chamber 1042 fills up, while the lower chamber 1041 empties, which allows adjustment of the connecting rod to its maximum length.

The second position P2 of the slide 111 corresponds to a maximum bearing force F exerted by the external controlling member 50 on the first shoe 113. In its second position P2, the slide 111 is configured to block fluidic communication with the hydraulic circuit 104. Due to the presence of the third valve 1046, which only authorizes the circulation of oil from the upper chamber 1042 to the lower chamber 1041, the fluid will gradually fill the lower chamber 1041 and empty the upper chamber 1042, until the connecting rod is adjusted to a minimum length.

As mentioned previously, in this embodiment as well as in all the other embodiments that will be set out, the combustion and inertial forces undergone by the connecting rod 10 will promote the circulation of oil, until reaching the targeted length of the connecting rod 10.

Tri-Rate Connecting Rod

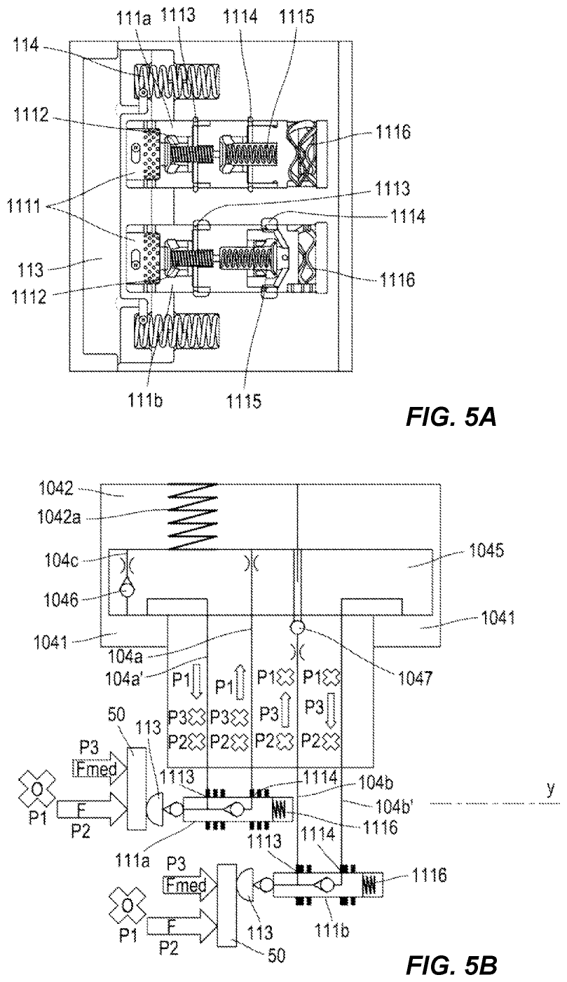

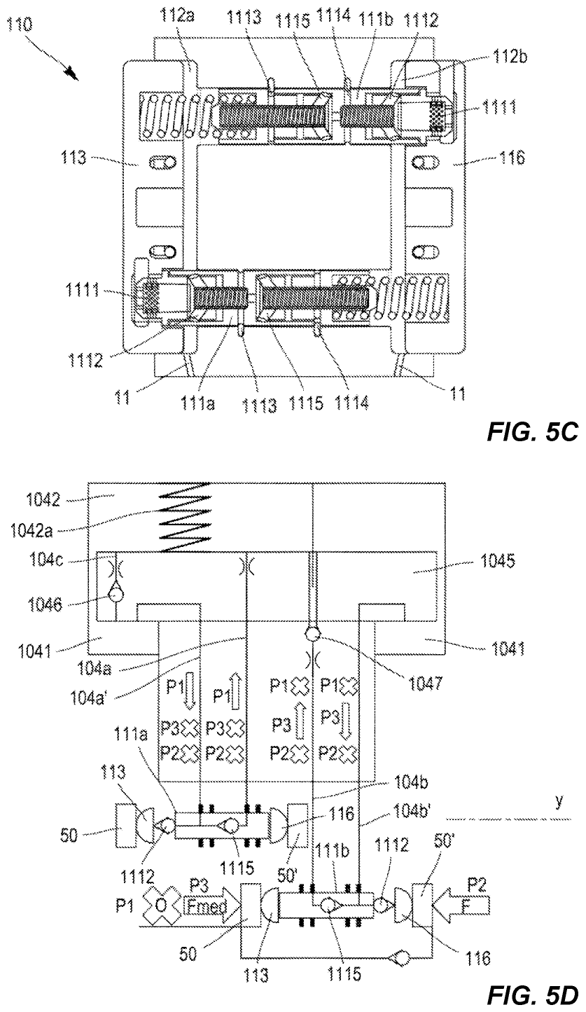

According to a third embodiment, the variable-length connecting rod 10 uses tri-rate operation, with transfer between the chambers 1041, 1042 of the hydraulic circuit 104 (FIGS. 5A, 5B). It should be recalled that a connecting rod 10 is called “tri-rate” when it can operate with three defined lengths: a maximum length corresponding to a maximal compression rate of the engine, an intermediate length and a minimum length corresponding to a minimal compression rate.

The third embodiment is described below with a telescopic connecting rod, but the control system 110 according to this third embodiment could equally well be applied to an eccentric connecting rod.

In this third embodiment, the control system 110 comprises two slides 111a, 111b. The hydraulic circuit 104 comprises four independent ducts 104a, 104a′, 104b, 104b′, two for connecting the first slide 111a on the one hand to the upper chamber 1042 and on the other hand to the lower chamber 1041, and two for connecting the second slide 111b on the one hand to the upper chamber 1042 and on the other hand to the lower chamber 1041. The central piston 1045 comprises a transfer duct 104c between the upper chamber 1042 and the lower chamber 1041, the valve 1046 of which (hereinafter called the third valve) allows the circulation of oil only from the upper chamber 1042 to the lower chamber 1041. The central piston 1045 further comprises a shutter device 1047, for example, in the form of a valve controlled by a needle (and hereinafter called fourth valve 1047), on the duct 104b connecting the second slide 111b and the upper chamber 1042.

Each slide 111a, 111b comprises a filter 1111, a first inlet valve 1112, a second valve 1115 and at least two orifices 1113, 1114 allowing establishment of fluidic communication with the hydraulic circuit 104 when the orifice 1113, 1114 is facing a duct 104a, 104a′, 104b, 104b′. The fluidic communication may include supplying oil to the hydraulic circuit 104 and circulating the oil from the lower chamber 1041 to the upper chamber 1042. Alternatively, the fluidic communication can be blocked, putting the hydraulic circuit 104 in a closed circuit.

The control system further comprises a spring 1116, arranged in the housing 112, against the end of each slide 111a, 111b, opposite the end secured to the first shoe 113 (FIG. 5A).

FIG. 5B illustrates the operation of the connecting rod 10 in accordance with this fourth embodiment. Provision is made for the two slides 111a, 111b to be able to occupy three different positions along the transverse axis y.

In the first slide resting position P1 (without force applied to the first shoe 113 by the external controlling member 50), the first slide 111a is configured to supply the upper chamber 1042 with oil and to allow oil to circulate from the lower chamber 1041 to the upper chamber 1042. The second slide 111b is configured to block fluidic communication with the hydraulic circuit 104. The upper chamber 1042 fills, while the lower chamber 1041 empties: the connecting rod 10 thus adjusts to its maximum length.

In the second position P2 of the slides 111a, 111b, corresponding to a maximum bearing force F exerted by the external controlling member 50 on the first shoe 113, the first slide 111a and the second slide 111b are configured to block fluidic communication with the hydraulic circuit 104. Due to the presence of the third valve 1046, which only authorizes the circulation of oil from the upper chamber 1042 to the lower chamber 1041, the fluid will gradually fill the lower chamber 1041 and empty the upper chamber 1042, until the connecting rod is adjusted to a minimum length.

The third position P3 of the slides 111a, 111b corresponds to a median bearing force F_{med} exerted by the external controlling member 50 on the first shoe 113. The presence of the spring 1116 in the housing 112 behind each slide prevents it from moving to the bottom of the housing 112 in the extreme position; the spring 1116 allows the implementation of a third position P3 between the first resting position P1 and the second (extreme) position P2 of the slides 111a, 111b.

In the third position P3, the first slide 111a is configured to block fluidic communication with the hydraulic circuit 104. The second slide 111b is configured to supply the upper chamber 1042 with oil and to allow oil to circulate between the lower chamber 1041 and the upper chamber 1042, when the fourth valve 1047 is opened by the needle: in practice, the needle will open the valve 1047 when the central piston 1045 reaches a determined position, typically an intermediate position in the cylinder. The upper chamber 1042 will then fill, and as soon as the central piston 1045 is below the determined position, the fourth valve 1047 will close and block the circulation of fluid between the two chambers. The oil will then tend to pass from the upper chamber 1042 to the lower chamber 1041 (due to the combustion and inertia forces undergone by the connecting rod) via the third valve 1046; the central piston 1045 will return to the determined position or beyond, which will have the consequence of opening the fourth valve 1047 again and restoring the circulation of fluid from the lower chamber 1041 to the upper chamber 1042, and so forth. In the third position P3, the slides 111a, 111b of the control system 110 will therefore make it possible to maintain the connecting rod 10 at an intermediate length, corresponding more or less to the determined (intermediate) position of the central piston 1045.

By way of example, starting from the first resting position P1 of the slides 111a, 111b, the third position P3 can be obtained by a translation of the slides 111a, 111b by 1 mm, and the second position P2 can be obtained by a translation of 2 mm.

According to a variant of this third embodiment of the connecting rod 10 according to the present disclosure, the control system 110 comprises at least one third shoe 116 arranged on the other sidewall of the connecting rod 10, opposite the sidewall on which the first shoe 113 and second shoe 115 are arranged (FIGS. 5C, 5D).

The control system 110 also comprises a fourth shoe 117, advantageously symmetrical with the third shoe 116 with respect to the center of the connecting rod head 102, playing the same role as the second shoe 115 but on the other side, for balancing the bearing forces likely to be exerted on the third shoe 116.

It will be understood that in this variant, two controlling members 50, 50′ will be necessary to exert bearing forces, on the one hand on the first 113 and second 115 shoes arranged on one sidewall of the connecting rod head 102, and on the other hand on the third 116 and fourth 117 shoes arranged on the other side of the connecting rod head 102.

In this variant of the third embodiment, the control system 110 comprises two slides 111a, 111b. Each slide can be moved in one direction along the transverse axis y due to a force applied to the first shoe 113, and in the other direction still along the transverse axis y, due to a force applied to the third shoe 116.

The hydraulic circuit 104 comprises four independent ducts 104a, 104a′, 104b, 104b′, a transfer duct 104c provided with a valve 1046 and a shutter device 1047, for example, in the form of a valve controlled by a needle as described in the third embodiment.

The slide 111a comprises a filter 1111, at its end secured to the first shoe 113, and the slide 111b comprises a filter 1111, at its end secured to the third shoe 116, through which the oil coming from the oil supply 11 passes. Each slide 111a, 111b also comprises a first inlet valve 1112, a second valve 1115 and at least two orifices 1113, 1114 allowing establishment of fluidic communication with the hydraulic circuit 104 (FIG. 5C). The fluidic communication may include supplying oil to the hydraulic circuit 104 and circulating the oil from the lower chamber 1041 to the upper chamber 1042. Alternatively, the fluidic communication can be blocked, putting the hydraulic circuit 104 in a closed circuit.

FIG. 5D illustrates the operation of the connecting rod 10 in accordance with this variant of the third embodiment. Provision is made for the two slides 111a, 111b to be able to occupy three different positions along the transverse axis y.

In the first slide resting position P1 (without bearing force applied to the first shoe 113 or to the third shoe 116 by an external controlling member 50, 50′), the first slide 111a is configured to supply oil to the upper chamber 1042 and to allow oil circulation from the lower chamber 1041 to the upper chamber 1042. The second slide 111b is configured to block fluidic communication with the hydraulic circuit 104. The upper chamber 1042 fills, while the lower chamber 1041 empties: the connecting rod 10 thus adjusts to its maximum length.

In the second position P2 of the slides 111a, 111b, corresponding to a maximum bearing force F exerted by one of the external controlling members 50′ on the third shoe 116 (no force being exerted on the first shoe 113), the first slide 111a and the second slide 111b are configured to block fluidic communication with the hydraulic circuit 104. Due to the presence of the third valve 1046, which only authorizes the circulation of oil from the upper chamber 1042 to the lower chamber 1041, the fluid will gradually fill the lower chamber 1041 and empty the upper chamber 1042, until the connecting rod is adjusted to a minimum length.

The third position P3 of the slides corresponds to a median bearing force F_{med} exerted by the other external controlling member 50 on the first shoe 113 (no force being exerted on the third shoe 116). It should be noted that a valve (illustrated in FIG. 5D) could be placed on the independent oil circuit (hereinafter referred to as the fluidic control circuit) actuating the external controlling members 50, 50′ to allow the actuation of one and the other controlling member 50, 50′, respectively, for two different oil pressures.

In the third position P3, the first slide 111a is configured to block fluidic communication with the hydraulic circuit 104. The second slide 111b is configured to supply oil to the upper chamber 1042 and to allow oil to circulate from the lower chamber 1041 to the upper chamber 1042, when the fourth valve 1047 is opened by the needle valve, which corresponds to a determined (intermediate) position of the central piston 1045. The upper chamber 1042 will then fill, and as soon as the central piston 1045 is below the determined position, the fourth valve 1047 will close and block the circulation of fluid between the two chambers. In the third position P3, the slides 111a, 111b of the control system 110 will therefore make it possible to maintain the connecting rod 10 at an intermediate length, corresponding to the determined (intermediate) position of the central piston 1045.

Continuous Rate Connecting Rod

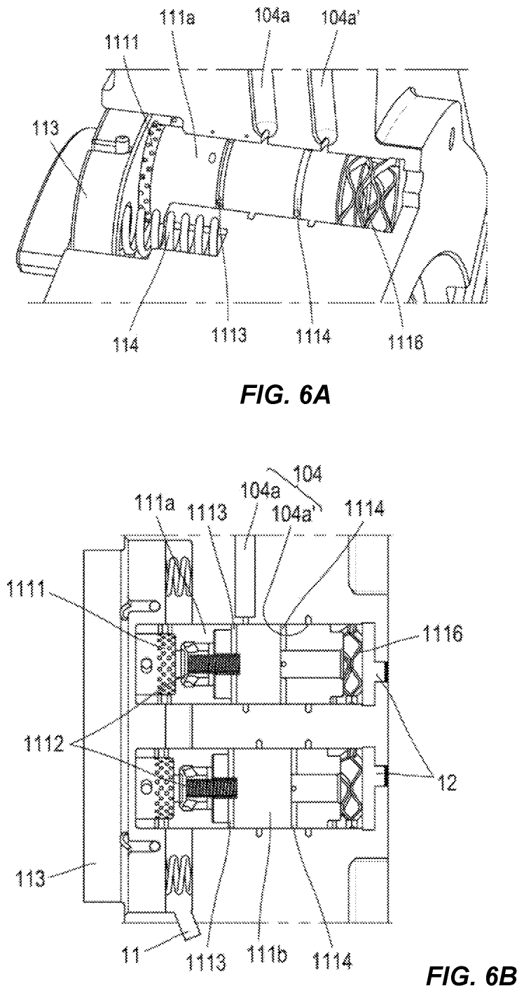

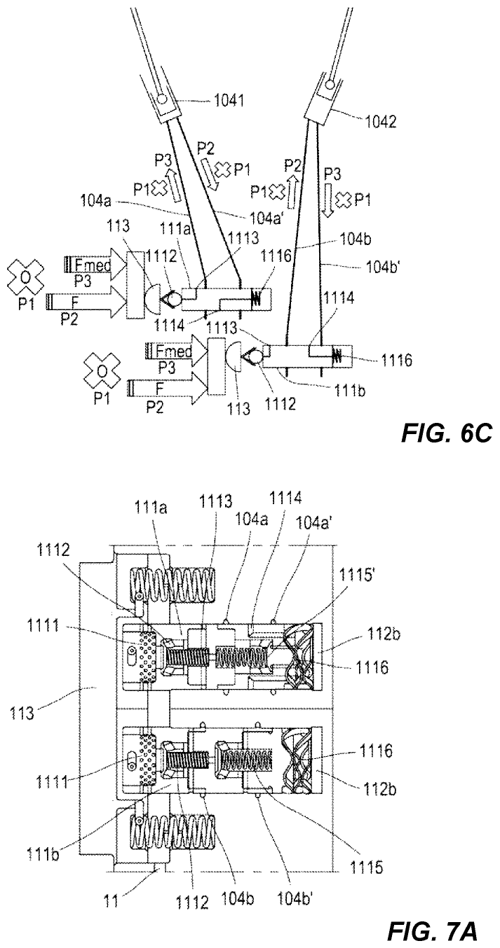

According to a fourth embodiment, the variable-length connecting rod 10 uses continuous rate operation, without transfer between the chambers 1041, 1042 of the hydraulic circuit 104 (FIGS. 6A-6C). The connecting rod 10 can thus operate with a plurality of lengths.

The fourth embodiment is described below with an eccentric connecting rod, but the control system 110 according to this fourth embodiment could equally well be applied to a telescopic connecting rod.

The control system 110 comprises two slides 111a, 111b. And the hydraulic circuit 104 comprises two independent ducts 104a, 104a′ to connect one of the two slides 111a to the first chamber 1041 and two independent ducts 104b, 104b′ to connect the other slide 111b to the second chamber 1042.

As illustrated in FIGS. 6A and 6B, each slide comprises a filter 1111, a first inlet valve 1112 and two orifices 1113, 1114 allowing establishment of fluidic communication with the hydraulic circuit 104 when one or other of the orifices 1113, 1114 is opposite a duct 104a, 104a′, 104b, 104b′. The fluidic communication can involve supplying the hydraulic circuit 104; the circulation of oil is then established from the supply 11 toward one of the ducts 104a, 104a′, 104b, 104b′ passing through the slide 111a, 111b. The fluidic communication can alternatively involve discharging the oil from the hydraulic circuit 104; the circulation of oil is then established from the duct 104a, 104a′, 104b, 104b′ toward the drain 12, passing through one of the slides 111a, 111b. Finally, the fluidic communication can be blocked, putting the hydraulic circuit 104 in a closed circuit.

The control system 110 comprises a spring 1116, arranged in the housing 112, against the end of each slide 111a, 111b, opposite the end secured to the first shoe 113.

FIG. 6C illustrates the operation of the connecting rod 10 in accordance with this fourth embodiment. Provision is made for the two slides 111a, 111b to be able to occupy three different positions along the transverse axis y, respectively called first position P1, second position P2 and third position P3. For the sake of clarity, the first resting position P1 will be discussed after mentioning the other two positions.

The second position P2 of the slides 111a, 111b corresponds to a maximum bearing force F exerted by the external controlling member 50 on the first shoe 113. In this second position P2, one of the slides 111a is configured to discharge the oil from the first chamber 1041 to which it is connected via the duct 104a′, the orifice 1114 of the slide 111a in fluidic communication with the rear section 112b of the housing 112 (and therefore with the oil drain 12) being located opposite the duct 104a′. The other slide 111b is configured to supply oil to the second chamber 1042 to which it is connected by the duct 104b (via the orifice 1113 of the second slide 111b, in fluid communication with the oil supply 11). In the second position P2 of the slides 111a, 111b, the second chamber 1042 is supplied with oil and the first chamber 1041 is emptied, which makes it possible to adjust the connecting rod to a minimum length, corresponding to a minimum rate of the engine.

The third position P3 of the slides 111a, 111b corresponds to a median bearing force F_{med} exerted by the external controlling member 50 on the first shoe 113. The presence of the spring 1116 in the housing 112 behind each slide 111a, 111b prevents it from moving to the bottom of the housing 112 in the extreme position; the spring 1116 allows the implementation of the third position P3 between the first resting position P1 and the second (extreme) position P2 of the slides 111a, 111b.

In this third position P3, one of the slides 111a is configured to supply oil to the first chamber 1041 and the other slide 111b is configured to discharge the oil from the second chamber 1042. In the third position P3 of the slides 111a, 111b, the first chamber 1041 is supplied with oil and the second chamber 1042 is emptied, which makes it possible to adjust the connecting rod to a maximum length, corresponding to a maximum rate of the engine.

The first resting position P1 of the slides 111a, 111b is obtained when no force is exerted on the first shoe 113. The two slides 111a, 111b are then configured to block fluidic communication with the hydraulic circuit 104. By putting the slides 111a, 111b in the first resting position P1, the hydraulic circuit 104 is found in a closed circuit: the connecting rod 10 can thus be maintained at an intermediate length, between its maximum length and its minimum length, corresponding to an intermediate engine rate. It is possible to gradually modify this intermediate length by applying impulses to the first shoe 113, at a maximum force F or at a median force F_{med}, depending on whether it is desired to limit or increase the intermediate length.

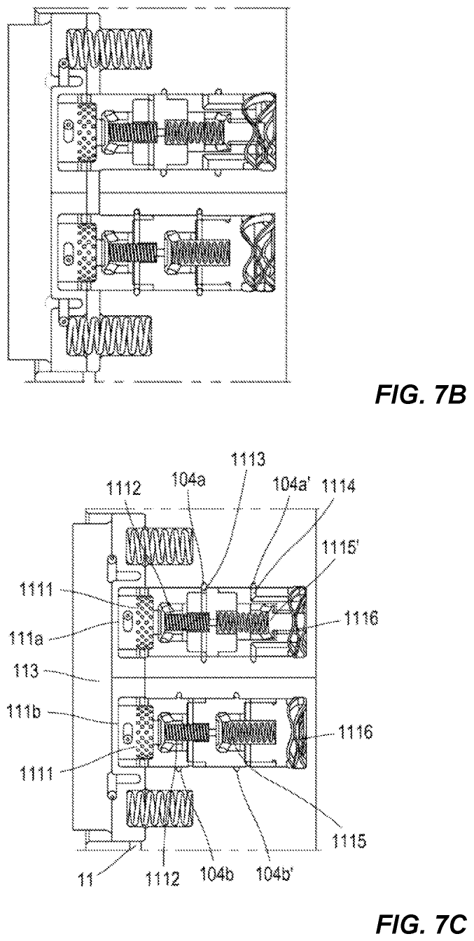

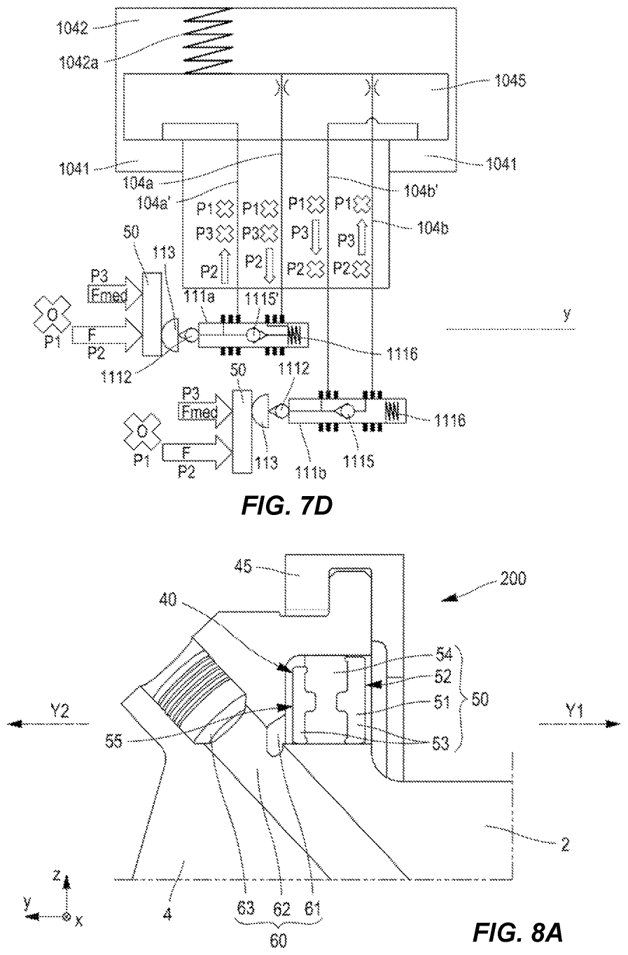

According to a fifth embodiment, the variable-length connecting rod 10 operates at a continuous rate, with transfer between the chambers 1041, 1042 of the hydraulic circuit 104 (FIGS. 7A-7D). The fifth embodiment is described below with a telescopic connecting rod, but the control system 110 according to this fifth embodiment could equally well be applied to an eccentric connecting rod.

The control system 110 comprises two slides 111a, 111b (FIG. 7A). The hydraulic circuit 104 comprises four independent ducts 104a, 104a′, 104b, 104b′, to connect each slide 111a, 111b to the two chambers 1041, 1042.

Each slide comprises a filter 1111, a first inlet valve 1112, a second valve 1115, 1115′, and at least two orifices 1113, 1114 allowing the establishment of fluidic communication with the hydraulic circuit 104 via the ducts 104a, 104a′, 104b, 104b′.

The fluidic communication may involve supplying the hydraulic circuit 104, and circulating the oil from the upper chamber 1042 to the lower chamber 1041, via the ducts 104a, 104a′, passing through the first slide 111a. Alternatively, the fluidic communication may include supplying the hydraulic circuit 104, and circulating the oil from the lower chamber 1041 to the upper chamber 1042, via the ducts 104b, 104b′, passing through the second slide 111b. Finally, the fluidic communication can be blocked, putting the hydraulic circuit 104 in a closed circuit.

The control system further comprises a spring 1116, arranged in the housing 112, against the end of each slide 111a, 111b, opposite the end secured to the first shoe 113.

FIG. 7D illustrates the operation of the connecting rod 10 according to this fifth embodiment. Provision is made for the two slides 111a, 111b to be able to occupy three different positions along the transverse axis y.

In the first resting position P1, occupied by the slides 111a, 111b in the absence of bearing force F exerted by the external controlling member 50, the first slide 111a and the second slide 111b are configured to block fluidic communication with the hydraulic circuit 104 (FIG. 7A). The hydraulic circuit 104 is then in a closed circuit, and the central piston 1045 is locked in its position, for example, an intermediate position. The connecting rod 10 thus has an intermediate length.

In the second position P2 of the slides (FIG. 7C), corresponding to a maximum bearing force F exerted by the external controlling member 50 on the first shoe 113, the first slide 111a is configured to supply oil to the lower chamber 1041 and to allow oil to circulate from the upper chamber 1042 to the lower chamber 1041, through the second valve 1115′ of the first slide 111a; this position P2 of the slide 111a therefore allows a transfer between the two chambers 1041, 1042. The second slide 111b is configured to block fluidic communication with the hydraulic circuit 104.

In this second position P2 of the slides, the lower chamber 1041 fills and the upper chamber 1042 empties: the connecting rod length decreases until it reaches a minimum length. By bringing the slides 111a, 111b into the first resting position P1 (the hydraulic circuit 104 then returning to a closed circuit), the connecting rod 10 can be maintained at various lengths between the intermediate length and the minimum length.

In the third position P3 of the slides 111a, 111b (FIG. 7B) corresponding to a median bearing force F_{med} exerted by the external controlling member 50 on the first shoe 113, the second slide 111b is configured to supply oil to the upper chamber 1042 and to allow oil to circulate from the lower chamber 1041 to the upper chamber 1042, via the second valve 1115 of the second slide 111b. This position P3 of the slide 111a allows a transfer between the two chambers 1041, 1042. The first slide 111a is configured to block fluidic communication with the hydraulic circuit 104.

In this third position P3 of the slides, the upper chamber 1043 fills and the lower chamber 1044 empties: the connecting rod length increases until it reaches a maximum length. By returning the slides to the first resting position P1 (the hydraulic circuit 104 then returning to a closed circuit), the connecting rod 10 can be maintained at various lengths between the intermediate length and the maximum length. The connecting rod 10 according to this fifth embodiment provides continuously variable length values to drive a continuous rate controlled compression ratio engine.

It should be noted that in all the stated embodiments in which no specific fluidic communication is established with the oil drain 12, the fact that the slides 111, 111a, 111b are mounted in the housing 112 of the connecting rod head 102 without sealing allows a progressive renewal of the oil of the hydraulic circuit 104, which avoids a degradation of the oil quality (degradation that could take place in a sealed closed circuit).

External Controlling Member Exerting the Bearing Force

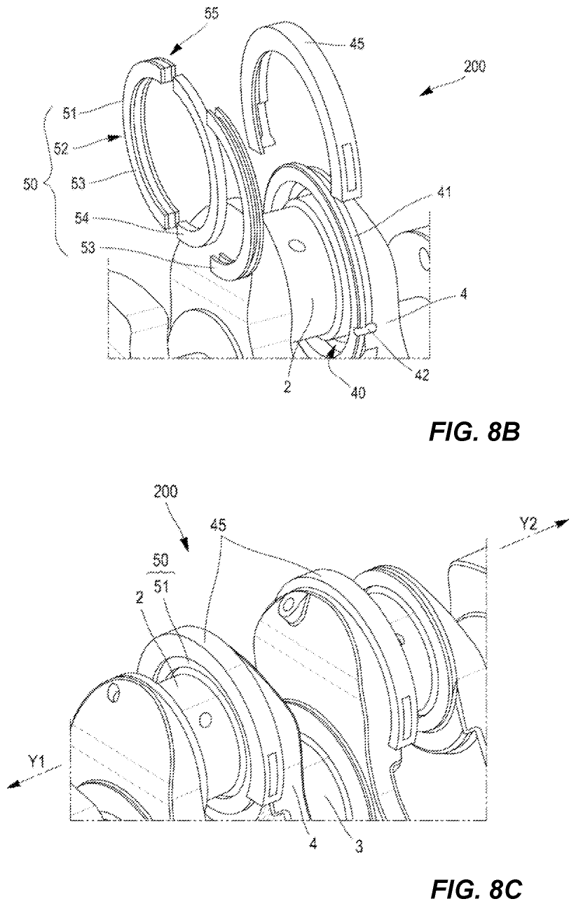

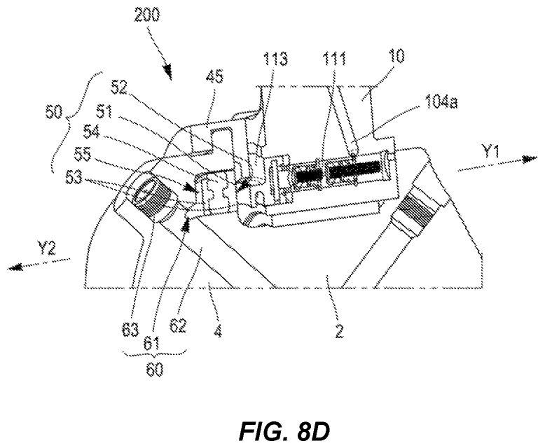

The following embodiments described with reference to FIGS. 8A-8D are given by way of examples and illustrate controlling members 50 external to the connecting rod 10, compatible with a connecting rod 10 according to the present disclosure.

The crankshaft 200 supporting the connecting rod 10 comprises at least one crankpin 2 and at least one journal 3 connected by a connecting arm 4. It further comprises at least one controlling member 50. The controlling member 50 is capable of moving in translation along the transverse axis y to cooperate with the first shoe 113 (and the second shoe 115) of the control system 110 of the connecting rod 10 length.

Preferably, the total stroke of the controlling member 50 varies from approximately 1 to 2 mm, depending on the configurations and embodiments. Of course, other strokes may be considered depending on the dimensions of the engine.

The controlling member 50 is arranged at the connecting arm 4, at one end of the crankpin 2. It comprises an annular part 51, a flat surface 52 of which extends in a plane (x, z) normal to the transverse axis y. The annular part 51 is coaxial with the crankpin 2 and it is capable of establishing continuous contact, via its flat surface 52, with the first shoe 113 (and the second shoe 115) of the control system 110, whatever the angular position of the crankshaft 1. Such a configuration has the advantage of an impact-free mechanical transmission, by applying a continuous bearing force to the first 113 and second 115 shoes.

The crankshaft 100 also comprises a fluidic control circuit 60 configured to move the controlling member 50 along the transverse axis y. The fluidic control circuit 60 comprises at least one orifice 61 intended to cause a fluid to communicate with a rear surface (opposite the flat surface 52) of the controlling member 50, in order to apply pressure to it and cause it to move. The fluid may be a gas or a liquid. A gaseous fluid has the advantage of being less influenced by the rotation of the crankshaft, compared to a liquid fluid, due to its very low density.

Advantageously, the fluidic control circuit 60 is formed by drilled ducts 62 over the entire length of the crankshaft 100, from one of its ends to the last crankpin 2, opposite this end. The fluidic circuit 60 has at least one fluid outlet orifice 61 at the connecting arm 4, as stated above, to communicate with the rear surface of the controlling member 50. The bores 62 in the crankshaft 100 are independent of the lubrication holes connecting the crankpin 2 and the journal 3. The fluidic control circuit 60 is sealed by a series of plugs 63 at the outlet of each bore 62 toward the outside of the crankshaft 1.

According to a particular embodiment of the controlling member 50, an annular cavity 40 is arranged in the connecting arm 4, at one end of the crankpin 2 (FIG. 8B). This cavity 40 is intended to form the cylinder body of an annular piston, which in turn is formed by the controlling member 50. An outlet orifice 61 for the fluid of the fluidic control circuit 60 opens into the cavity 40. The connecting arm 4 also comprises an external centering 41, coaxial with the crankpin 2, as well as two lug housings 42, the function of which will be outlined later. The controlling member 50 comprises two half-frames 53, for example, with an H-shaped profile, designed to be assembled around the crankpin 2, then positioned in the annular cavity 40. Advantageously, the half-frames 53 are metallic. Pins are provided to align and secure the two half-frames 53 after they have been fitted.

On each of the half-frames 53, an elastomer 54 is molded over to provide sealing between the rear surface 55 and the flat surface 52 of the controlling member 50, when the latter is placed in the annular cavity 40. It should be noted that with this type of annular piston with seal, the friction torque generated by these same seals is greater than that of the contact with the shoe 113 of the connecting rod 10. It therefore seems pointless to add an anti-rotation system at the controlling member 50.

The crankshaft 200 comprises a yoke joint 45 centered at the external centering 41 and clipped directly onto the connecting arm 4, at the lug housings 42. The yoke joint 45 forms an end stop of the controlling member 50, when the latter moves along the transverse axis y, in the first direction Y1. It preferably has an annular segment, allowing standardization of the abutment points against the annular part 51 of the controlling member 50. Advantageously, the yoke joint 45 can also act as a lateral abutment for the connecting rod head 102.

The annular part 51 of the controlling member 50 (forming the annular piston) has a flat surface 52 capable of establishing continuous contact against the first 113 and the second 115 shoes. Contact with the shoes 113, 115 can be established when the controlling member 50 is moved in the first direction Y1 (FIGS. 8A, 8C). This movement is caused by the application of a fluid pressure on the rear surface 55 of the controlling member 50. The fluid is routed to the annular cavity 40 (at the rear of the controlling member 50) by a duct 62 of the fluidic control circuit 60. The depressurization of the fluidic control circuit 60 causes a displacement of the controlling member 50 in the second direction Y2, and thus interrupts the contact with the shoes 113, 115. Alternatively, a return element can be arranged, so as to push back the controlling member 50 when the fluid pressure on its rear surface 55 drops below a threshold value.

According to a variant, a controlling member 50, 50′ is arranged at each connecting arm 4, on either side of each crankpin 2 of the crankshaft 200. Such a configuration can allow the control of a tri-rate connecting rod 10 comprising a first 113 and a second 115 shoe on one sidewall of the connecting rod head 102, and a third 116 and a fourth 117 shoe on the other sidewall, as outlined in the variant of the third embodiment of the connecting rod 10 (tri-rate connecting rod).

It should be noted that this variant of the controlling member also allows the control of two connecting rods 10, when the crankpin 2 is precisely configured to receive two connecting rods 10.

Variable Compression Ratio Engine

The present disclosure also relates to a controlled variable compression ratio engine, which may have an in-line or V-shaped architecture. The engine comprises an engine block and a crankshaft 200 as described above, arranged in the engine block. The engine further comprises at least one variable-length connecting rod 10 as described above, associated with a crankpin 2 of the crankshaft 200.

The fluidic control circuit 60 of the crankshaft 200 is connected to the outside by the end of the crankshaft 200. The end is arranged to receive a rotating seal allowing the connection between the rotating part (crankshaft) and the stationary part (engine block), thus allowing the fluidic connection of the control circuit 60 with an external control assembly, arranged outside the engine block. The external control assembly is configured to convey the fluid into the control circuit 60. It comprises, in particular, a pressure source such as, for example, an air compressor, when the fluid is compressed air. To place the control circuit 60 under vacuum (and to control the movement of the controlling member 50 in the second direction Y2), the external control assembly can also comprise a dedicated or pooled vacuum pump. The external control assembly is controlled by the engine control unit (computer), depending on the engine speed and load.

Of course, the present disclosure is not limited to the various embodiments described and it is possible to add variant embodiments without departing from the scope of the invention as defined by the claims.

1. A variable-length connecting rod having a body that extends along a longitudinal axis, the connecting rod comprising:
a connecting rod head, designed to establish a pivot connection, along a transverse axis perpendicular to the longitudinal axis, with a crankpin of a crankshaft;
a hydraulic circuit for controlling the length of the connecting rod;
a control system for controlling the hydraulic circuit, the control system comprising:
at least one linear hydraulic slide, arranged within a housing of the connecting rod head, and capable of occupying a first resting position and at least one second position, each position allowing fluidic communication with the hydraulic circuit to be opened or closed;
at least a first shoe arranged on a sidewall of the connecting rod head and secured to one end of the slide, suitable for undergoing a bearing force exerted by an annular controlling member, coaxial with the crankpin and external to the connecting rod, the bearing force allowing the slide to be moved into the second position position;
a return device configured to bring the slide back to its first resting position in the absence of the bearing force; and
at least a second shoe arranged on the sidewall of the connecting rod head and suitable for undergoing the bearing force.

2. The variable-length connecting rod of claim 1, wherein the first and second shoes are arranged so that a center of gravity of the forces that the shoes undergo when the bearing force is applied to them is located substantially at the center of the connecting rod head.

3. The variable-length connecting rod of claim 1, wherein at least one of the shoes comprises end stops to limit its possible movement along the transverse axis.

4. The variable-length connecting rod of claim 1, wherein the hydraulic circuit comprises at least two hydraulic chambers, each connected to the slide by at least one duct, the chambers being associated with at least one hydraulic piston, the movement of which is suitable for modifying the length of the connecting rod along the longitudinal axis.

5. The variable-length connecting rod of claim 4, wherein the at least one slide makes it possible, depending on the position it occupies, to establish oil circulation between a hydraulic chamber and an oil supply, or to establish oil circulation between a hydraulic chamber and an oil drain, or to establish oil circulation between the two hydraulic chambers, or to block any circulation of oil with the two hydraulic chambers.

6. The variable-length connecting rod of claim 5, wherein the oil supply is configured to recover lubricating oil from the connecting rod head bearings.

7. The variable-length connecting rod of claim 5, wherein the at least one slide comprises at least one valve allowing the direction of oil circulation to be defined.

8. The variable-length connecting rod of claim 4, wherein the hydraulic circuit comprises a duct connecting the two hydraulic chambers and includes a valve allowing the direction of oil circulation to be defined.

9. The variable-length connecting rod of claim 4, comprising a return or push-back element connected to at least one hydraulic piston.

10. The variable-length connecting rod of claim 4, wherein at least one duct, connecting a hydraulic chamber and the slide, comprises a shutter device configured to allow the circulation of oil between the hydraulic chamber and the slide when the hydraulic piston reaches a determined position.

11. The variable-length connecting rod of claim 2, wherein at least one of the shoes comprises end stops to limit its possible movement along the transverse axis.

12. The variable-length connecting rod of claim 11, wherein the hydraulic circuit comprises at least two hydraulic chambers, each connected to the slide by at least one duct, the chambers being associated with at least one hydraulic piston, the movement of which is suitable for modifying the length of the connecting rod along the longitudinal axis.

13. The variable-length connecting rod of claim 12, wherein the at least one slide makes it possible, depending on the position it occupies, to establish oil circulation between a hydraulic chamber and an oil supply, or to establish oil circulation between a hydraulic chamber and an oil drain, or to establish oil circulation between the two hydraulic chambers, or to block any circulation of oil with the two hydraulic chambers.

14. The variable-length connecting rod of claim 13, wherein the oil supply is configured to recover lubricating oil from the connecting rod head bearings.

15. The variable-length connecting rod of claim 14, wherein the at least one slide comprises at least one valve allowing the direction of oil circulation to be defined.

16. The variable-length connecting rod of claim 15, wherein the hydraulic circuit comprises a duct connecting the two hydraulic chambers and includes a valve allowing the direction of oil circulation to be defined.

17. The variable-length connecting rod of claim 16, comprising a return or push-back element connected to at least one hydraulic piston.

18. The variable-length connecting rod of claim 17, wherein at least one duct, connecting a hydraulic chamber and the slide, comprises a shutter device configured to allow the circulation of oil between the hydraulic chamber and the slide when the hydraulic piston reaches a determined position.
